(19) United States
(12) Patent Application Publication
(10) Pub. No.: US 2011/0080715 A1
(43) Pub. Date: Apr. 7, 2011

(54) PROTECTIVE STRUCTURE OF ELECTRONIC COMPONENT

(75) Inventor: Lin Chiao-Li, Taipei (TW)

(73) Assignee: CASTLES TECHNOLOGY CO., LTD., Hsin-Tien (TW)

(21) Appl. No.: 12/574,777

(22) Filed: Oct. 7, 2009

(51) Int. Cl. H05K 1/14; G06F 21/00

(52) U.S. Cl. 361/784; 726/22

(57) ABSTRACT

The present invention discloses a protective structure of an electronic component comprises a first circuit board, a second circuit board, and a chip module. The first circuit board is provided thereon with a hollow accommodating space and a plurality of first electrode contacts. The second circuit board is provided thereon with a plurality of second electrode contacts. The chip module is disposed in an area enclosed by the second electrode contacts. The hollow accommodating space is topped with the second circuit board such that the chip module is encapsulated between the second circuit board and the hollow accommodating space. Upon detection of separation of the first and second circuit boards under an external force or detection of a short circuit caused to an electrical circuit inside the first circuit board or the second circuit board, the chip module activates a security protection mechanism for deleting information stored thereon so as to prevent the information from being abused.

### BACKGROUND OF THE INVENTION

1. Field of the Invention

The present invention relates to a protective structure of an electronic component, and more particularly, wherein the protective structure comprises a first circuit board, a second circuit board, and a chip module to thereby allow the chip module electrically connected to the first circuit board and the second circuit board to be encapsulated between the second circuit board and a hollow accommodating space.

2. Description of the Prior Art

Owing to ever-evolving technology, plenty of high-tech or high-precision electronic components nowadays are likely to fall prey to hackers and therefore are vandalized or tampered with. The hackers may even pry into passwords or operation of a program related to the electronic components with a view to stealing important data from the electronic components.

To ward off vandalism, tampering, or prying carried out by unscrupulous persons, U.S. Pat. No. 6,853,093B2 provides a circuit board structure for activating a protection mechanism whenever electrical circuits of the circuit board structure are destroyed, so as to prevent data from being stolen and tampered with. U.S. Pat. No. 6,853,093B2 discloses a plurality of printed circuit boards defining a protected enclosure wall for enclosing important electronic components on the primary circuit board of an electronic device, wherein another circuit board coupled to the other electronic components by soldering is disposed above the protected enclosure wall so as to encapsulate the important electronic components on the primary circuit board.

Although the above-described conventional protective structure of a circuit board is effective in warding off vandalism, tampering, or prying carried out by unscrupulous persons, the process of stacking a plurality of printed circuit boards defining a protected enclosure wall is rather intricate, difficult, and time-consuming, and involves taking too many steps.

### BRIEF SUMMARY OF THE INVENTION

In view of the above defects of the prior art, the inventor of the present invention resorted to past experience, imagination, and creativity, performed tests and modification repeatedly, and eventually devised the present invention—a protective structure of an electronic component.

The first objective of the present invention is to provide a protective structure of an electronic component, wherein the protective structure essentially comprises as few constituent elements as possible, namely a first circuit board and a second circuit board, and is fabricated by a streamlined process so as to reduce production costs and yet be as efficient as a conventional protective structure in terms of the degree of protection provided.

The second objective of the present invention is to provide a protective structure of an electronic component, the protective structure comprises a first circuit board with a plurality of first electrode contacts thereon and a second circuit board with a plurality of second electrode contacts thereon so as to: create electrical connection between the first circuit board and the second circuit board by soldering the first electrode contacts and the second electrode contacts to each other; and thus, upon detection of vandalism done to the electrical connection between the first circuit board and the second circuit board, a security protection mechanism is activated to prevent important information from theft and misappropriation.

The third objective of the present invention is to provide a protective structure of an electronic component, comprising a first circuit board provided thereon with a hollow accommodating space and a second circuit board disposed thereon with a chip module so as for the chip module to be encapsulated between the second circuit board and the hollow accommodating space and thereby well protected when the second circuit board closes the hollow accommodating space of the first circuit board.

The fourth objective of the present invention is to provide a protective structure of an electronic component, wherein the protective structure comprises a chip module, and the chip module further comprises an information-storing chip and a security protection chip for controlling the information-storing chip. The security protection chip activates a security protection mechanism as soon as the protective structure is vandalized or a short circuit occurs to an electrical circuit provided inside the protective structure. With the activated security protection mechanism, all the data stored on the information-storing chip are deleted so as to prevent important information from being stolen or tampered with.

The present invention provides a protective structure of an electronic component, comprising: a first circuit board provided with an electrical circuit therein and provided thereon with a hollow accommodating space and a plurality of first electrode contacts electrically connected to the electrical circuit inside the first circuit board and positioned on a periphery of the hollow accommodating space; a second circuit board provided with an electrical circuit therein and provided thereon with a plurality of second electrode contacts electrically connected to the electrical circuit inside the second circuit board, wherein the plural first electrode contacts and the plural second electrode contacts are equal in quantity and corresponding in position to each other, wherein the second circuit board is disposed on the first circuit board in a way that the second electrode contact-provided side of the second circuit board faces the hollow accommodating space of the first circuit board, wherein the plural first electrode contacts of the first circuit board and the plural second electrode contacts of the second circuit board are soldered to each other so as for electrical connection to be formed between the electrical circuit of the first circuit board and the electrical circuit of the second circuit board; and a chip module disposed on a same side of the second circuit board as the plural second electrode contacts and positioned in an area defined and enclosed by the plural second electrode contacts, wherein the hollow accommodating space of the first circuit board is topped with the second circuit board so as for the chip module to be encapsulated between the second circuit board and the hollow accommodating space, wherein the chip module further comprises at least one information-storing chip and at least one security protection chip for preventing information stored on the information-storing chip from being stolen or tampered with, the information-storing chip being electrically connected to the security protection chip, and the security protection chip being electrically connected to the electrical circuit inside the second circuit board.

### BRIEF DESCRIPTION OF THE SEVERAL VIEWS OF THE DRAWINGS

FIG. 1 is an exploded perspective view of a preferred embodiment of the present invention;

FIG. 2 is an exploded perspective view of the preferred embodiment of the present invention from another angle of view;

FIG. 3 is a perspective view of the preferred embodiment of the present invention;

FIG. 4 is a cross-sectional view of the preferred embodiment of the present invention; and

FIG. 5 is a cross-sectional view of an information-storing chip in the preferred embodiment of the present invention.

### DETAILED DESCRIPTION OF THE INVENTION

To achieve the above and other objectives and functions, the present invention provides a protective structure of an electronic component. The protective structure essentially comprises simple constituent elements and thereby is advantageous. The framework of the protective structure and the principle of protection provided by the present invention are illustrated hereunder with preferred embodiments of the present invention.

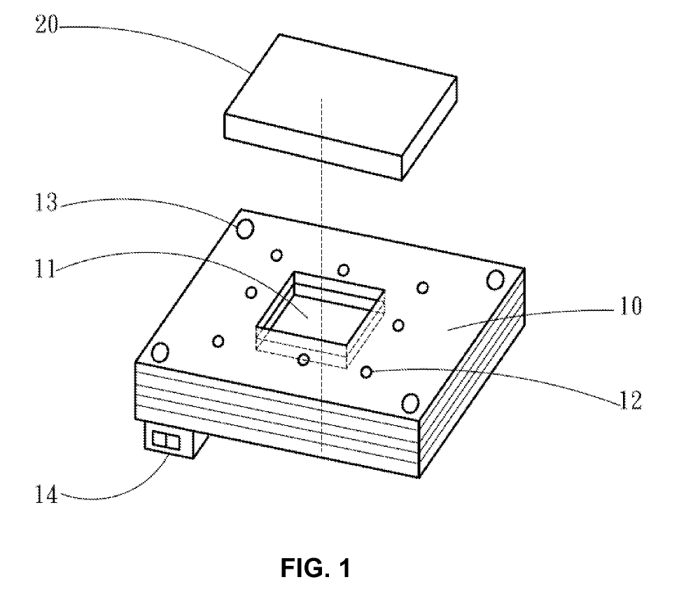

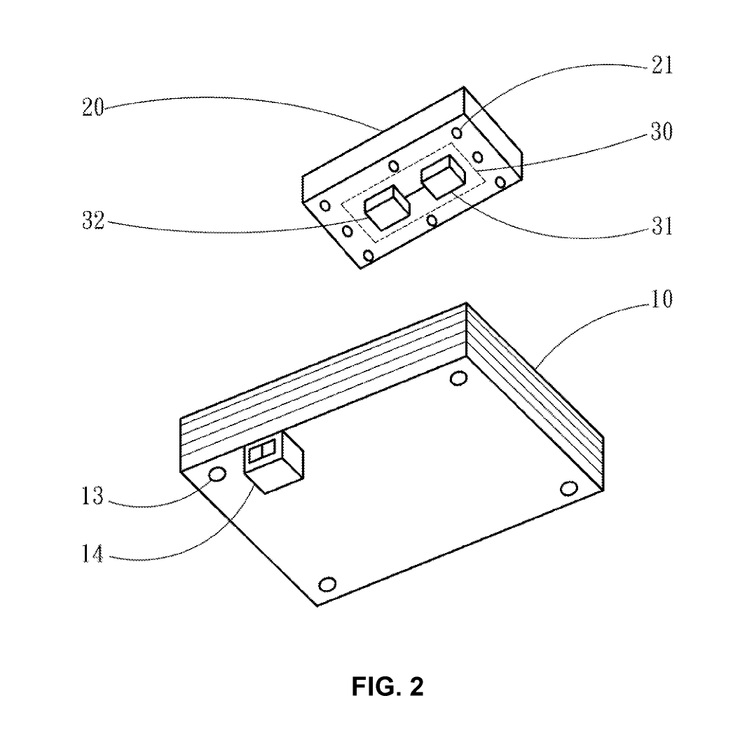

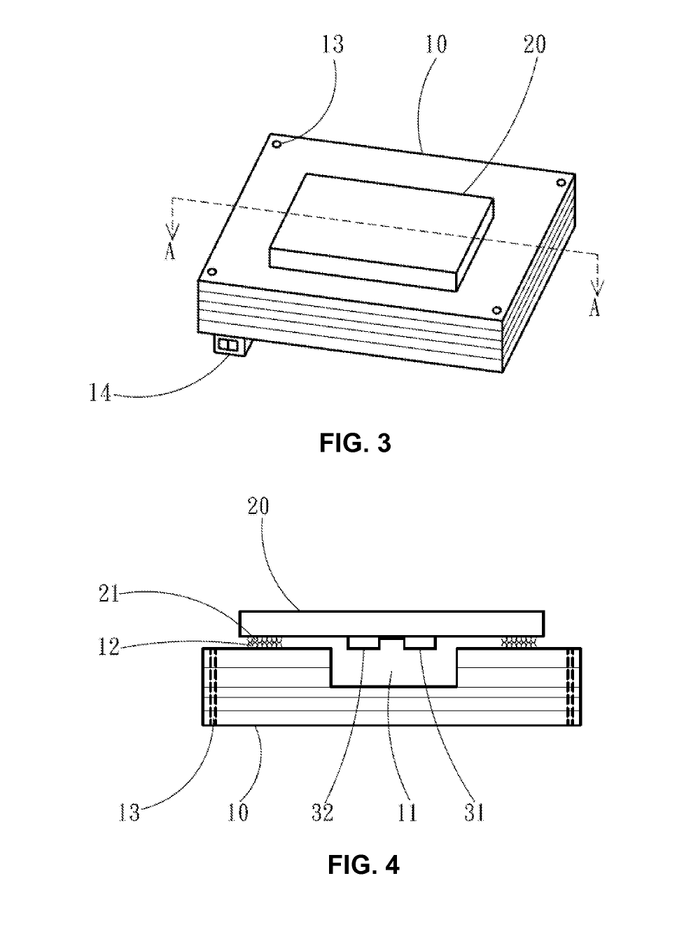

The specific embodiments of the present invention are best understood by reading the specification of the present invention while making reference to FIGS. 1, 2, 3, and 4. Referring to FIG. 1, there is shown an exploded perspective view of a preferred embodiment of the present invention. Referring to FIG. 2, there is shown an exploded perspective view of the preferred embodiment of the present invention from another angle of view. Referring to FIG. 3, there is shown a perspective view of the preferred embodiment of the present invention. Referring to FIG. 4, there is shown a cross-sectional view of the preferred embodiment of the present invention, and the cross-sectional view is taken along the line A-A in FIG. 3. The protective structure of an electronic component comprises a first circuit board 10, a second circuit board 20, and a chip module 30.

The first circuit board 10 is provided with an electrical circuit therein. A hollow accommodating space 11 and a plurality of first electrode contacts 12 are provided on one side of the first circuit board 10. The plural first electrode contacts 12 are electrically connected to the electrical circuit provided inside the first circuit board 10 and are positioned on the periphery of the hollow accommodating space 11. The first circuit board 10 is a multilayered board. The hollow accommodating space 11 is formed by cutting outermost ones of the layers of said multilayered first circuit board 10. The first circuit board 10 is further provided with a plurality of screw-receiving holes 13 and an external circuit connector 14. The plural screw-receiving holes 13 are configured to screw the first circuit board 10 to the casing of an electronic product. The external circuit connector 14 is electrically connected to the electrical circuit inside the first circuit board 10.

The second circuit board 20 is provided with an electrical circuit therein. A plurality of second electrode contacts 21 are provided on one side of the second circuit board 20 and electrically connected to the electrical circuit inside the second circuit board 20. The plural second electrode contacts 21 and the plural first electrode contacts 12 on the first circuit board 10 are equal in quantity and corresponding in position to each other. The second circuit board 20 is disposed on the first circuit board 10 in such a way that the second electrode contact-provided side of the second circuit board 20 faces the hollow accommodating space 11 of the first circuit board 10. The plural first electrode contacts 12 of the first circuit board 10 and the plural second electrode contacts 21 of the second circuit board 20 are soldered to each other so as for electrical connection to be formed between the electrical circuit of the first circuit board 10 and the electrical circuit of the second circuit board 20.

The chip module 30 and the plural second electrode contacts 21 are disposed on the same side of the second circuit board 20. The chip module 30 is positioned in an area defined and enclosed by the plural second electrode contacts 21. The hollow accommodating space 11 of the first circuit board 10 is topped with the second circuit board 20 so as for the chip module 30 to be encapsulated between the second circuit board 20 and the hollow accommodating space 11. The chip module 30 further comprises an information-storing chip 31 and a security protection chip 32 for preventing information stored on the information-storing chip 31 from being stolen or tampered with. The information-storing chip 31 and the security protection chip 32 are electrically connected to each other. The security protection chip 32 is electrically connected to the electrical circuit inside the second circuit board 20.

In the above preferred embodiment, with the chip module 30 being encapsulated between the hollow accommodating space 11 of the first circuit board 10 and the second circuit board 20, the chip module 30 is hermetically sealed and thereby cannot be reached from outside.

The reason why the security protection chip 32 of the chip module 30 is capable of preventing information stored on the information-storing chip 31 from being stolen or tampered with is described below. The security protection chip 32 is electrically connected to the first circuit board 10 and the second circuit board 20. Any structural damage done by an external force to the first circuit board 10 and the second circuit board 20 that harms or leads to short circuit to the circuit boards inside two said circuit boards will be detected by the security protection chip 32 and a security protection mechanism is thereby activated for deleting information stored on the information-storing chip 31, so as to prevent the information from being stolen, tampered with, or impertinently monitored.

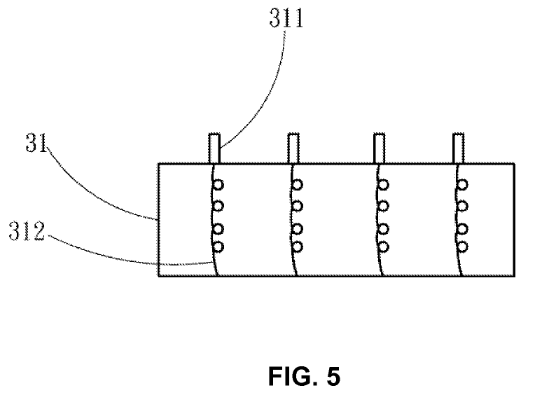

Referring to FIG. 5, there is shown a cross-sectional view of an information-storing chip in the preferred embodiment of the present invention. As shown in the drawing, the information-storing chip 31 is provided with a plurality of fuses 312 therein and a plurality of input/output pins 311 electrically connected to the fuses 312, respectively. Any structural damage done by an external force to the first circuit board 10 and the second circuit board 20 that harms or leads to short circuit to the circuit boards inside two said circuit boards will be detected by the security protection chip 32 and a security protection mechanism is thereby activated for burning out fuses 312 inside the information-storing chip 31 to cause an open circuit to the input/output pins 311 of the information-storing chip 31, thereby preventing the information from being stolen, tampered with, or impertinently monitored.

According to the above description of a protective structure of an electronic component of the present invention, the present invention has the following advantages:

The present invention discloses using only two multilayered circuit boards as a protective structure and therefore dispenses with other complicated protective elements. Hence, the present invention is effective in cutting production costs and yet is as efficient as a conventional protective structure in terms of the degree of protection provided.

The present invention enhances protection for an electronic component because the present invention discloses cutting the multilayered first circuit board to form a hollow accommodating space therein and encapsulating the electronic component in the hollow accommodating space of the first circuit board by a second circuit board.

What is claimed is:

1. A protective structure of an electronic component, comprising:
a first circuit board provided with an electrical circuit therein and provided thereon with a hollow accommodating space and a plurality of first electrode contacts electrically connected to the electrical circuit inside the first circuit board and positioned on a periphery of the hollow accommodating space;
a second circuit board provided with an electrical circuit therein and provided thereon with a plurality of second electrode contacts electrically connected to the electrical circuit inside the second circuit board, wherein the plural first electrode contacts and the plural second electrode contacts are equal in quantity and corresponding in position to each other, wherein the second circuit board is disposed on the first circuit board in a way that the second electrode contact-provided side of the second circuit board faces the hollow accommodating space of the first circuit board, wherein the plural first electrode contacts of the first circuit board and the plural second electrode contacts of the second circuit board are soldered to each other so as for electrical connection to be formed between the electrical circuit of the first circuit board and the electrical circuit of the second circuit board; and
a chip module disposed on a same side of the second circuit board as the plural second electrode contacts and positioned in an area defined and enclosed by the plural second electrode contacts, wherein the hollow accommodating space of the first circuit board is topped with the second circuit board so as for the chip module to be encapsulated between the second circuit board and the hollow accommodating space;
wherein the chip module further comprises at least one information-storing chip and at least one security protection chip for preventing information stored on the information-storing chip from being stolen or tampered with, the information-storing chip being electrically connected to the security protection chip, and the security protection chip being electrically connected to the electrical circuit inside the second circuit board.

2. The protective structure of claim 1, wherein the first circuit board is a multilayered board, and the hollow accommodating space is formed by cutting outermost ones of layers of multilayered said first circuit board.

3. The protective structure of claim 1, wherein the first circuit board is further provided with a plurality of screw-receiving holes for screwing the first circuit board to a casing of an external electronic product.

4. The protective structure of claim 1, wherein the first circuit board is further provided with at least one external circuit connector electrically connected to the electrical circuit inside the first circuit board.

5. The protective structure of claim 1, wherein the security protection chip deletes information stored on the information-storing chip upon detection of damage done to the electrical circuit inside the first circuit board or the second circuit board.

6. The protective structure of claim 1, wherein the security protection chip deletes information stored on the information-storing chip upon detection of a short circuit caused to the electrical circuit inside the first circuit board or the second circuit board.

7. The protective structure of claim 1, wherein the information-storing chip is provided with a plurality of fuses therein and a plurality of input/output pins electrically connected to the fuses, respectively.

8. The protective structure of claim 7, wherein the security protection chip causes the fuses inside the information-storing chip to burn out upon detection of damage done to the electrical circuit inside the first circuit board or the second circuit board.

9. The protective structure of claim 7, wherein the security protection chip causes the fuses inside the information-storing chip to burn out upon detection of a short circuit caused to the electrical circuit inside the first circuit board or the second circuit board.
